(19) United States
(12) Patent Application Publication
(10) Pub. No.: US 2013/0208740 A1
(43) Pub. Date: Aug. 15, 2013

(54) AMPLIFICATION DEVICE WITH FREQUENCY DRIFT FOR A PULSED LASER

(71) Applicant: Gilles Cheriaux, Fresnes (FR)

(72) Inventor: Gilles Cheriaux, Fresnes (FR)

(73) Assignees: Ecole Nationale Superieure de Techniques Avancees, Paris (FR); Ecole Polytechnique, Palaiseau (FR)

(21) Appl. No.: 13/813,444

(22) PCT Filed: Aug. 2, 2011
(86) PCT No.: PCT/FR11/51861

§ 371 Date: Apr. 26, 2013

(30) Foreign Application Priority Data
Aug. 3, 2010 (FR) 10 56 414

(51) Int. Cl. H01S 3/10

(52) U.S. Cl. CPC H01S 3/10038
USPC 372/21; 372/25

(57) ABSTRACT

An amplification device with frequency drift for a pulsed laser includes a stretcher temporally stretching an incident laser pulse, at least one amplifying medium for amplifying the stretched laser pulse, and a compressor for temporally compressing the stretched and amplified laser pulse. The compressor includes an amplifying medium for amplifying a partially temporally compressed laser pulse, increasing energy yield of the amplifier.

### FIELD OF THE INVENTION

The present invention relates to an amplification device with frequency drift for an intense pulsed laser, using the so-called frequency drift amplification technology.

This technology is used to produce very short lasting laser pulses, for example approximately several femtoseconds, and with a very strong peak power.

### BACKGROUND

Pulse lasers, or pulsed lasers, make it possible to achieve high instantaneous powers for a very short length of time, in the vicinity of several picoseconds (10⁻¹² s) or several femtoseconds (10⁻¹⁵ s). In these lasers, an ultra-short laser pulse is generated in an oscillator before being amplified in an amplifying medium. The laser pulse initially produced, even with low energy, creates a high instantaneous power, since the energy from the pulse is delivered in an extremely short amount of time.

To make it possible to increase the energy of the laser pulse without the very high instantaneous power generating nonlinear effects, it has been considered to temporally stretch the pulse before its amplification, then to recompress it after amplification. The instantaneous powers used in the amplifying medium can thus be decreased. This method, called frequency drift amplification (also often called “chirped pulse amplification,” or CPA), makes it possible to increase the duration of a pulse by a factor of approximately 10³ to 10⁵, then to recompress it so that it returns to its initial duration.

This CPA method, described in the article by D. Strickland and G. Mourou entitled “Compression of amplified chirped optical pulses” (Opt. Commun. 56, 219-221—1985), uses a spectral decomposition of the pulse, making it possible to impose a path with a different length to the various wavelengths to shift them temporally.

FIG. 1 diagrammatically shows the amplification of a laser pulse using this chirped pulse amplification method.

An oscillator 1 emits a laser pulse 91, called input pulse, with a very short duration ΔT, for example 10 femtoseconds, and a relatively low energy E, for example in the order of several nanojoules. This input pulse 91 passes through a stretcher 2, which distributes the various spectral components over time as a function of their wavelength.

Several methods can be used to produce the stretcher 2.

FIG. 3 thus shows the arrangement of a stretcher 2 implementing diffraction gratings reflecting the incident light rays with a different orientation depending on the wavelength. The structure of such a stretcher is in particular described in the article by O. E. Martinez, “3000 times grating compressor with positive group velocity dispersion: application to fiber compensation in 1.3-1.6 μm region” (IEEE Journal of Quantum Electronics, Vol. qe-23, p. 59, 1987).

The input pulse 91 is sent onto a first grating 21, which disperses it spectrally. As an illustration, three rays 911, 913 and 912, respectively corresponding to two spectral components with extreme wavelengths of the pulse 91 and one spectral component with a median wavelength, are shown in FIG. 3.

The beam made up of the spectral components, in particular 911, 912 and 913, making up the laser pulse then passes through an optical system 22, which makes those various optical components converge. The optical system 22 has a first focal point F1 placed at the rear of the grating 21 and a second focal point F′1 placed at the rear of a second grating 23, placed at the same distance from the focal point F′1 as the grating 21 from the focal spot F1.

The different spectral components of the laser pulse, in particular 911, 912 and 913, are returned by that second grating 23 parallel to each other and spatially spread out, toward a third grating 24, symmetrical with the grating 23, which disperses the pulse for the optical system 25, symmetrical with the optical system 22. This optical system 25 having the focal points F2 and F′2 focuses all of the spectral components, in particular 911, 912 and 913, on the same point of a fourth grating 26, symmetrical to the grating 21, which returns all of the spectral components in a same direction to form a new laser pulse 92.

The subassemblies formed on the one hand by the grating 21, the optical system 22 and the grating 23 and, on the other hand, by the grating 24, the optical system 25 and the grating 26, are symmetrical to each other. It is therefore possible, according to one typical embodiment, to use only one of these subassemblies to form the structure by placing a fold-over dihedron between the gratings 23 and 24. The gratings 21 and 23 and the optical system 22 can then respectively play the role of gratings 26 and 24 and of the optical system 25.

The different spectral components, in particular 911, 912 and 913, forming the input pulse 91 do not travel along the same path in the stretcher 2. Depending on the construction of that stretcher 2, the components with a shorter wavelength can thus travel along a longer path, or on the contrary along a shorter path, than the components with a longer wavelength. This difference in travel length causes a time offset of the spectral components according to their wavelength in the pulse 92, which is called a stretched pulse.

This stretched pulse 92 consequently has a longer length than the duration ΔT of the input pulse 91, which may for example be approximately 10⁵ ΔT. This greater length causes a very significant decrease in the instantaneous power of this pulse 92 relative to that of the input pulse 91, which allows it to be amplified under better conditions.

It should be noted that the different diffraction gratings 21, 23, 24 and 26 making up the stretcher 2 each have an energy yield in the limited dispersive order. The passage of the input pulse 91 through these four gratings therefore causes a significant energy loss.

Another method used to stretch laser pulses is the propagation of those pulses in optical fibers over long distances. The group velocity dispersion of the spectral components of the pulse in the material at the core of the fiber makes it possible to obtain the desired temporal elongation. This solution is preferably used for relatively long pulses. In fact, during the compression by a compression system using diffraction gratings for a very short pulse thus stretched, aberrations due to the different dispersion laws of the gratings and the optical fibers may appear.

Still another known stretching method consists of a Bragg diffraction grating made from a photosensitive material, the pitch of which is not constant with respect to the thickness. The different spectral components of the laser pulse are then reflected at different depths, which creates a delay for some of the spectral components relative to others and thereby stretches the pulse.

Such a method is in particular described in the articles by Vadim Smirnov, Emilie Flecher, Leonid Glebov, Kai-Hsiu Liao and Almantas Galvanauskas, “Chirped bulk Bragg gratings in PTR glass for ultrashort pulse stretching and compression” (Proceedings of Solid State and Diode Lasers Technical Review. Los Angeles 2005, SS2-1.).

The stretched pulse 92 leaving the stretcher 2 is then amplified using traditional amplifying mediums, which increase its power. As an example, three amplifying mediums are shown in FIG. 1.

The first amplifying medium 3 increases the power of the stretched pulse 92 until giving it an energy of approximately 10⁶ times the energy E of the incident pulse 91, for example several millijoules.

The second amplifying medium 4 and the third amplifying medium 5 each increase the power of the laser pulse such that the amplified stretched pulse 93 has an energy of approximately 10¹⁰ times the energy E of the input pulse 91, for example 25 joules.

Although the pulse has a relatively significant energy, its duration is relatively long, which makes its peak power weak enough to avoid the nonlinear effects in the amplifying mediums 3, 4 and 5.

It should be noted that the amplification in the amplifiers 3, 4 and 5 requires a significant contribution of pumping energy in those amplifiers. In fact, the energy saved by the laser pulse during its passage in amplifying medium only corresponds to approximately 45% of the pumping energy provided to the amplifying medium.

The amplifying medium used is most often a stimulated emission amplifying medium, such as a Titanium-doped Sapphire crystal, for example.

According to one possible alternative, the amplification of the laser pulse may be done using a method typically called Optical Parametric Chirped Pulse Amplification, which combines parametric laser pulse amplification with the chirped pulse amplification technique. In that case, the amplification of the stretched pulse occurs in a material having significant nonlinear properties, for example crystals of the TDP (Potassium Dihydrogen Phosphate), BBO (Beta Barium Borate) or LBO (Lithium Triborate) type.

In this case, the amplification consists of transferring energy from the photons of the optical pumping pulse to the photons of the pulse to be amplified. The wave vectors of the amplified pulse and the optical pumping pulse must therefore be phase-matched, and the two pulses must be synchronous.

Such an amplification method is in particular described in the article by A. Dubietis et al. entitled “Powerful femtosecond pulse generation by chirped and stretched pulse parametric amplification in BBO Crystal” (Opt. Commun. 88, 433 (1992)).

Amplifiers using stimulated emission amplification or parametric amplification are indifferently referred to as “amplifying mediums” in the rest of the patent application.

The return of the pulse to a short duration, close to the duration ΔT of the input pulse, is done using an optical device called a compressor 6 comprising four diffraction gratings 61, 62, 63 and 64 reflecting the incident light rays with a different orientation depending on the wavelength.

Thus, a first grating 61 spectrally disperses the stretched pulse 93. As an illustration, the three rays 911, 912 and 913, corresponding to two extreme wavelengths of the pulse 910 and one median wavelength, are shown in FIG. 1.

A second grating 62 partially returns the spectral components, in particular 911, 912 and 913, making up the laser pulse, which are thus spatially spread out. The third grating 63 makes it possible to assemble these various spectral components on a same point of the fourth grating 64, which returns all of those spectral components, in particular 911, 912 and 913, in a same direction, to form a new laser pulse 94.

The different spectral components, in particular 911, 912 and 913, forming the input pulse 91 do not travel along the same path in the compressor 6. More specifically, the compressor 6 is built such that the spectral components that have a longer path in the structure 2 have a shorter path in the compressor 6. This difference in the path length causes a time offset of the spectral components according to their wavelength that is opposed to the spectral offset generated by the stretcher 2.

Thus, the spectral components that were temporally delayed in the pulse 92 or 93 make up their delay, such that all of the spectral components are temporally gathered in an output pulse 94 having a duration similar to the duration ΔT of the input pulse 91, for example 20 femtoseconds, and a very significant peak power, for example approximately 10¹⁴ W.

It should be noted that the different diffraction gratings 61, 62, 63 and 64 making up the compressor 6 each have an energy field in the limited dispersive order, for example approximately 90%. The passage of the pulse 93 through these four gratings therefore causes a significant energy loss. As an example, if the energy of the pulse 93 before compression is 25 joules, the energy of the output pulse 94 may be approximately 15 joules.

The chirped pulse amplification technique therefore makes it possible to produce laser powers with a very high instantaneous power, but generates very significant energy losses.

Thus, the obtainment of an output pulse of 15 joules requires a pulse before compression of 25 joules, nearly all of the energy of which is provided by the amplifiers. The amplifiers having an energy yield of approximately 45%, it is necessary to provide a pumping energy of approximately 55 joules to obtain the output pulse of 15 joules. The overall energy yield of the chirped pulse amplifier is therefore less than 30%.

The production of a high-energy laser pulse therefore requires a very significant energy contribution, which makes it necessary to have very significant and very expensive installations, in particular for pumping.

### OBJECTIVE OF THE INVENTION

The aim of the present invention is to offset these drawbacks of the prior art.

In particular, the invention aims to increase the energy yield of the chirped laser pulse amplification, so as to make it possible to obtain a high-energy laser pulse with a lower pumping energy.

The invention thus aims to enable the obtainment of pulses having the same energy as in the prior art with less significant and less expensive installations and lower energy consumption.

Another aim of the invention is to allow the obtainment of laser pulses having an energy higher than those obtained in the prior art, without increasing the pumping power, and therefore the significance and cost of the pumping installations.

### SUMMARY OF THE INVENTION

These aims, as well as others that will appear more clearly hereafter, are achieved using an amplification device with frequency drift for a pulsed laser, successively comprising:

a stretcher able to temporally stretch an incident laser pulse;

at least one amplifying medium able to amplify the stretched laser pulse;

a compressor able to temporally compress the stretched and amplified laser pulse, in which, according to the invention, the compressor comprises an amplifying medium, so as to amplify the partially temporally compressed laser pulse.

The energy losses of the pulse thus amplified at the end of its temporal compression are thus reduced relative to the energy losses of a pulse amplified before undergoing a temporal compression.

Furthermore, the elements of the compressor placed before the amplifier placed in the compressor must withstand a much lower energy pulse than if the pulse was completely amplified before its compression.

Advantageously, the amplifying medium placed in the compressor is placed in a position where the duration of the laser pulse is substantially half of the duration of the pulse penetrating the compressor.

The amplifying medium is thus placed between two subassemblies of the compressor, each performing half of the temporal compression of the pulse previously considerably stretched. In the known amplifiers, the pulse is spatially spread out in that position.

Preferably, the compressor comprises four successive dispersive systems and the amplifying medium that is placed between the second and third dispersive systems.

Preferably, the dispersive systems are dispersion gratings.

According to one advantageous embodiment of the invention, the first and second dispersive systems of the compressor are placed in the open air, and the third and fourth dispersive systems of the compressor are placed in a vacuum chamber.

Such a compressor is easier to implement and less expensive than the compressors of the prior art that must fully withstand the significant energy of a completely amplified pulse before its compression, all of the elements of which had to be contained in a vacuum chamber.

Advantageously, the stretcher uses at least one dispersion grating.

Advantageously, the amplifying medium placed in the compressor is made up of a doped crystal enabling amplification by stimulated emission.

According to one advantageous embodiment of the invention, the amplifying medium placed in the compressor has a doping gradient, such that the different spectral components making up the laser pulse pass through portions of the amplifying medium having different doping levels.

When the laser pulse is spatially spread according to its wavelength, as is the case in the known optical compressors, it is thus possible to perform a variable amplification as a function of the wavelength. This characteristic may for example make it possible to offset the gain difference of the laser pulse as a function of the wavelengths in certain amplifying materials.

According to one advantageous embodiment of the invention, at least one of the amplifying mediums used is made up of a nonlinear crystal enabling a parametric amplification of the laser pulse.

The invention also relates to an optical compressor capable of temporally compressing a laser pulse previously stretched, characterized in that it comprises an amplifying medium, so as to amplify the laser pulse that is partially temporally compressed.

### BRIEF DESCRIPTION OF DRAWING FIGURES

The present invention will be better understood upon reading the following description of preferred embodiments of the invention, provided as illustrative and non-limiting examples, and accompanied by the drawings, in which:

FIG. 1, already described above, is a simplified diagram of an amplification device with frequency drift for a laser pulse, according to the prior art;

FIG. 2 is a simplified diagram of an amplification device with frequency drift for a laser pulse according to one embodiment of the invention;

FIG. 3 is a simplified diagram of a stretcher used for the chirped pulse amplification of a laser pulse.

### DETAILED DESCRIPTION

FIG. 2 diagrammatically shows an amplification device with frequency drift according to one embodiment of the invention. The elements of this amplification device that are identical to the device of the prior art described in FIG. 1 bear the same references.

As in the prior art, an oscillator 1 emits an input laser pulse 91 that passes through a stretcher 2. The temporally stretched pulse 92 leaving the stretcher 2 can pass through one or more amplifying mediums 3 and 4.

The modification made by the present invention relates to the compressor 7. This compressor, like the compressor 6 of the prior art, includes four diffraction gratings 71, 72, 73 and 74 respectively playing the same roles as the gratings 61, 62, 63 and 64 of the prior art. However, according to the invention, an amplifying medium 8 is placed in the compressor 7, between the second diffraction grating 72 and the third diffraction grating 73 making up the compressor. This amplifier may compensate the energy lost in the diffraction gratings 71 and 72.

The pulse 96 passing through this amplifying medium 8 has different characteristics from the pulse 95 leaving the amplifier 4 and penetrating the compressor 7, due to its passage through the first two diffraction gratings 71 and 72. Thus, it has a duration approximately 2 times shorter than the duration of the pulse 95, for example approximately 250 picoseconds if the duration of the pulse 95 is approximately 500 picoseconds. Furthermore, this pulse 96 is spatially spread out, the shortest wavelengths being on one side and the longest wavelengths on the other.

The passage of the pulse 96 in the amplifying medium 8 produces the amplified pulse 97 having the same temporal stretching and spatial spreading characteristics as the pulse 96.

This pulse 96 then continues its compression by passing through the gratings 73 and 74, spatially recompressing the pulse and completing its temporal compression, to form the output pulse 98 with a short duration and high peak power.

Due to the position of the amplifying medium 8 in the compressor, the pulse 97 leaving the amplifying medium undergoes a less significant energy loss during its passage through the diffraction gratings 73 and 74 than if it had passed through the four gratings making up the compressor.

As an example, if the diffraction gratings used each have an energy yield in the dispersive order of 90%, the energy loss of the pulse due to the passage through the two gratings 73 and 74 is 19%.

Thus, the obtainment of an output pulse 98 of 15 joules requires a pulse 97 leaving the amplifying medium 8 of approximately 18.5 joules. Furthermore, the energy loss of approximately 19% due to the passage of the pulse through the two gratings 71 and 72 is very low, approximately 0.5 joules, due to the low energy of the beam before it passes in the amplifying medium.

Because the amplifying mediums have an energy yield in the vicinity of 45%, the total pumping energy to be supplied to those amplifying mediums is approximately 40 joules.

It is therefore possible, with the compression device according to the invention, to provide a laser pulse having a given power while consuming a pumping power of less than approximately 30% of that consumed by an amplification device with frequency drift according to the prior art, to provide a pulse with the same power.

It should be noted that the compressor 6 can have a slightly different structure from that described. It is for example possible, in one particular embodiment, for the subassemblies formed on the one hand by the gratings 71 and 72, and on the other hand by the gratings 73 and 74 to be folded over traditionally, using a fold-over dihedron, so that a single subassembly is traveled through twice by the laser pulse.

This embodiment is not, however, preferred to implement the present invention. In fact, in the embodiment illustrated by FIG. 2, the two gratings 71 and 72, receiving a low-energy pulse, can have a smaller dimension than the gratings 61 and 62 of the compressor of the prior art. It is consequently possible to use less expensive gratings, and under more flexible conditions. It is for example possible for these two gratings 71 and 72 to be in the open air, while the assembly of the gratings making up the compressors of the prior art must be placed in a vacuum chamber.

During the amplification of the laser pulse 96 in the amplifying medium 8, the wavelengths forming that pulse are spatially distributed according to their wavelength.

According to one embodiment of the invention, the amplifying medium 8 can offer constant amplification at all points, which is obtained when the doping is radially uniform in the crystal.

According to another advantageous embodiment of the invention, it is possible to use a variable amplification according to the passage position of each component of the laser pulse in the amplifying medium. This different amplification may for example be done with an amplifying medium having a doping gradient in a direction perpendicular to the passage direction of the laser pulse.

Such a doping gradient exists naturally, for example, in titanium sapphire crystals. It is possible, as needed, to accentuate this natural radial doping gradient, for example by using large crystals (for example larger than 80 mm in diameter). The doping is then weaker at the center than at the edge of the crystal, which creates less significant energy storage at the center than on the edges and therefore a lower potential gain at the center.

This variable amplification depending on the spatial position makes it possible to implement a variable amplification depending on the wavelength for laser pulses spatially spread out as a function of the wavelength that passes through the amplifying medium 8. The spectral gain of the pulse may in fact be more significant for wavelengths passing through the center of the crystal that is more strongly doped.

Such a different amplification for the different spectral components of the pulse may be implemented in all cases where the spectral components of the laser pulse are spatially spread out. It may for example be useful to offset the gain difference of the laser pulse and a titanium sapphire crystal as a function of the wavelengths.

1. An amplification device with frequency drift for a pulsed laser, successively comprising:
a stretcher for temporally stretching an incident laser pulse;
at least one amplifying medium for amplifying a laser pulse that has been stretched; and
a compressor for temporally compressing the laser pulse that has been stretched and amplified, wherein the compressor comprises an amplifying medium for amplifying a partially temporally compressed laser pulse, to increase energy yield of the amplifier.

2. The amplification device according to claim 1, wherein the amplifying medium located in the compressor positioned where duration of the laser pulse is substantially half of the duration of a pulse penetrating the compressor.

3. The amplification device according to claim 1, wherein
the compressor comprises first, second, third, and fourth successive dispersive systems, and
the amplifying medium is placed between the second and third dispersive systems.

4. The amplification device according to claim 3, wherein the first, second, third, and fourth dispersive systems are dispersion gratings.

5. The amplification device according to claim 3, wherein the first and second dispersive systems are located in open air, and the third and fourth dispersive systems are located in a vacuum chamber.

6. The amplification device according to claim 1, wherein the stretcher includes at least one dispersion grating.

7. The amplification device according to claim 1, wherein the amplifying medium located in the compressor includes a doped crystal for amplification by stimulated emission.

8. The amplification device according to claim 7, wherein the amplifying medium located in the compressor has a doping gradient, such that different spectral components of the laser pulse pass through portions of the amplifying medium having different doping levels.

9. The amplification device according to claim 1, wherein at least one of the amplifying mediums comprises a nonlinear crystal for parametric amplification of the laser pulse.

10. An optical compressor for temporally compressing a laser pulse that has been previously stretched, comprising an amplifying medium, for amplifying a laser pulse that is partially temporally compressed, to increase energy yield of an amplifier including the compressor.

11. The optical compressor according to claim 10, comprising first, second, third, and fourth successive dispersive systems wherein the amplifying medium located between the second and third dispersive systems.

12. The compressor according to claim 10, wherein the first, second, third, and fourth dispersive systems are dispersive gratings.

13. The compressor according to claim 10, wherein the first and second dispersive systems are located in open air and the third and fourth dispersive systems are located in a vacuum chamber.
